(19) United States
(12) Patent Application Publication
(10) Pub. No.: US 2022/0135854 A1
(43) Pub. Date: May 5, 2022

(54) IMPROVED CORRUGATING ADHESIVES

(71) Applicant: CORN PRODUCTS DEVELOPMENT, INC., Westchester, IL (US)

(72) Inventor: Roman SKURATOWICZ, Bridgewater, NJ (US)

(21) Appl. No.: 17/427,320

(22) PCT Filed: Jan. 8, 2020
(86) PCT No.: PCT/US2020/012667

§ 371 Date: Jul. 30, 2021

Related U.S. Application Data
(60) Provisional application No. 62/802,473, filed on Feb. 7, 2019.
(60) Provisional application No. 62/940,330, filed on Nov. 26, 2019.

(51) Int. Cl. C09J 103/10; C08K 3/22; C08K 3/38; C08B 31/00; C08B 31/18

(52) U.S. Cl. CPC C09J 103/10; C08K 3/22; C08K 3/38; B65H 45/30; C08B 31/18; C08K 2201/019; C09J 2403/00; C08B 31/003

(57) ABSTRACT

Disclosed herein is a starch based corrugating adhesive comprising modified starch, and methods for making such corrugating adhesive. In some embodiments, the corrugating adhesive may contain a carrier component comprising a gelatinized modified starch, and a suspended component comprising a granular modified starch. In some embodiments, the granular and gelatinized modified starch may be from the same base starch. In some embodiments, the modified starch is obtained from a starch having an amylose content between about 30% and less than 40%. Also disclosed herein are corrugated materials made using the corrugating adhesives described herein.

This Application claims priority to U.S. Provisional Patent Application Ser. No. 62/802,473 and U.S. Provisional Patent Application Ser. No. 62/940,330 both of which are incorporated herein in their entirety.

Disclosed herein are starch-based adhesives and, more particularly, improved starch based corrugating adhesives.

Starch-based corrugating adhesives can be made in several styles. Regardless of composition or style, corrugating adhesives are generally expected to flow freely, even when containing relatively high solids content and to gel rapidly to form a strong adhesive bond between substrates. Additionally, it is common practice to add other chemicals to an adhesive composition to increase its functionality. For example, boron containing compounds are added to increase adhesive tack and bonding performance. As another example, wet strength resins such as ketone-aldehyde resins are added to increase the adhesive's wet bond strength. Such chemicals, however, are regulated in discharge water. So it would be useful to develop corrugating adhesives having high tack and wet bond strength that either contain fewer chemical additives, such as, e.g., boron or ketone-aldehyde resins or are substantially free of these chemical additives.

### BRIEF DESCRIPTION OF THE FIGURES

The present technology may be further understood with reference to the following figures which are illustrative, and which are not intended to limit the full scope of the technology in anyway.

FIG. 1 depicts a single face portion of a corrugating machine.

FIG. 2 depicts the double back, (also called double face or glue machine) portion of a corrugating machine.

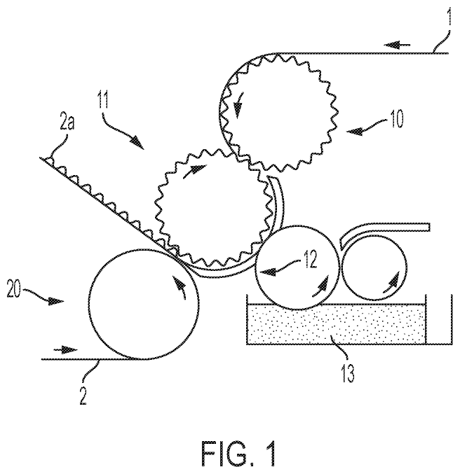

The disclosed technology pertains to improved corrugating adhesives, which may be used on any industry standard corrugating equipment and applied to any standard web material and face material. With reference to FIG. 1, a corrugated board may be made as follows. Web material (also called a medium) (1) is fed along the upper corrugating roller (10), where it is corrugated between upper corrugating roller (10) and lower corrugating roller (11). The corrugated web material then passes by adhesive applicator (12), which may apply any embodiment of the corrugating adhesive disclosed herein (13) to the flutes on a first side of the web material. The distance between adhesive applicator (12) and the lower corrugating roller may be called the single face (S/F) adhesion gap. The web material and adhesive may be affixed to a single face material (2) (also called a single face liner), which may be paper or other suitable substrate by the pressure developed between a single face roller (20) and lower corrugating roller (11) to form a single faced corrugated material (2a). In any embodiment, disclosed herein, the web material can be affixed to the single face material (2) using heat and high pressure for a short time. In any embodiment, disclosed herein, a corrugating machine may be configured to affix a single face material and web material using a hard nip, or with a flexible belt, or other similar process.

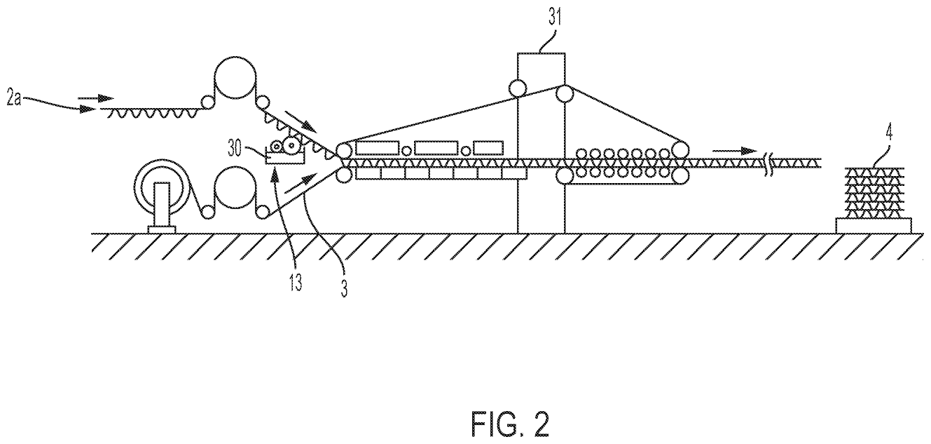

Any embodiment of the corrugating adhesive disclosed herein may be, if desired, applied to the flutes on a second side of the web material. The flutes may then be affixed to a double back (also called second face) material. For example, with reference to FIG. 2, an adhesive applicator (30) may apply any embodiment of the corrugating adhesive disclosed herein (13) to the flutes on the second side of the web material of the singled faced corrugated material (2a). The flutes are then affixed to a double back (D/B) material (3) by double back liner (31) to form double backed (or double faced) corrugated material (4). In any embodiment, the double back material is affixed to the web material using low pressure (compared to the pressure used to affix the web material to the single face material) and is heated for a longer time (compared to the time used to affix the web material to the single face material). The affixed single face material, web material, and double back material form a single wall corrugated material. Additionally, by similar mechanism, any embodiment of the corrugating adhesive disclosed herein may be used to affix a second web or further additional webs between the single face and double back or to a third face material to form a double web, double wall or higher web, or wall corrugated material. In other embodiments, the double back portion of a corrugating machine may use different types of glue rolls or metering rods of different style or size to apply any embodiment of the corrugating adhesive disclosed herein.

In any embodiment, the strength of an adhesive bond can be measured by a testing method referred to as measuring the dry pin adhesion, also called dry pins. This test method measures the force needed to break the bond between the web material and one of the two faces (single face material or double back material). Dry pins are measured with the methods and apparatuses set forth in Technical Association of the Pulp and Paper Industry (TAPPI) technical document T-821.

In any embodiment, the strength of the water resistant or wet adhesive bond strength of any embodiment of the corrugating adhesive disclosed herein can be measured by several methods including, e.g. wet pin adhesion (wet pins), ply separation (TAPPI T-812), or FEFCO (European Federation of Corrugated Board Manufacturers) No. 9 methods. Within this specification, wet pin measurements are obtained as follows. Wet pins are measured by submerging the board for 24 hours in water, then measuring pin adhesion. The test method followed is TAPPI method T-845, and discussions on wet strength are outlined in TAPPI technical information paper (TIP) 0305-69.

Wet pins and dry pins may be measured on the bond between the web and the single face material, or between the web and the double back material. Wet pins and dry pins are commonly measured in pounds (force) per linear inch or Newtons per linear meter.

In any embodiment, the water resistance of an adhesive disclosed herein can be characterized according to the relation between wet pins and dry pins. Within this specification, an adhesive having wet pins equal to about 1% to about 3% of the dry pins is referred to as a moisture resistant adhesive (MRA). Within this specification, an adhesive having wet pins equal to about 3% to about 7% of the dry pins is referred to as a water resistance adhesive (WRA). Within this specification, an adhesive having wet pins equal to about 5% to about 10% of the dry pins is referred to as an adhesive having the highest level of water protection (WPA).

In any embodiment, a corrugating adhesive disclosed herein has a wet pins to dry pins ratio (%) of about 1% to about 10% or about 1% to 7% or about 2% to about 7% or about 3% to about 7%. In any embodiment, a corrugating adhesive has a wet pins to dry pins ratio (%) of about 3% to about 6% or about 3% to about 5%. In any embodiment paper board can made more quickly having substantially the same or increased pin strength (dry or wet) compare to board made using pearl corn adhesives without performance or wet strength additives. In any embodiment, double wall production of board can run at least about 1.25 time faster than the same production processes using a pearl corn adhesive or at least about 1.5 times or at least about 1.75 time or at least about 2 times (or up to about 2 times or 2 times faster).

In any embodiment, the viscosity of an adhesive disclosed herein may be measured in seconds required to pass through a Stein-Hall-cup, such viscosity may be called a Stein-Hall viscosity and may be measured in Stein-Hall seconds. In any embodiment, a Stein-Hall viscosity of a corrugating adhesive disclosed herein may be measured as follows. The adhesive is placed in a calibrated Stein Hall cup which has been equilibrated to adhesive temperature. The adhesive is optionally strained to remove particulates. The adhesive drains from the bottom orifice in the cup and a stopwatch is used to time the adhesive at it passes from the first to second pin in the cup. Both time in seconds and adhesive temperature are recorded as values, because adhesive viscosity will change with temperature.

The present technology pertains to corrugating adhesives including a starch having an amylose content of about 30% to less than 40, or about 30% to about 39% or about 33% to about 38%. In any embodiment, a starch has an amylose content of about 34% to about 36%. In any embodiment, a starch from a single source has an amylose content of about 35%. In any embodiment, the amylose content of a corrugating adhesive disclosed herein is provided by a starch from a single source. In any embodiment, a corrugating adhesive disclosed herein includes starch from a legume (family leguminosae), including but not limited to chick pea, lentil, fava bean and pea and examples thereof. In any embodiment, a corrugating adhesive disclosed herein includes pea starch (starch from the seed of the plant Pisum sativum sometimes called field pea or yellow pea).

In any embodiment, an amylose content of a starch can be determined by potentiometric titration using the following method. Starch samples (about 0.5 g) are mixed with about 10 ml of concentrated calcium chloride solution (about 30% wt.) and are heated to 95° C. for 30 minutes. Samples are cooled to room temperature, diluted with 5 ml of 2.5% uranyl acetate solution. The mixture is centrifuged for 5 minutes at 2000 rpm and filtered to give a clear solution. Total starch concentration is measured polarimetrically using 1 cm polarimetric cell, and amylose is measured by direct titration of the solution using aliquots (about 5 ml) of 0.01N iodine solution. Using a platinum electrode and while recording KCl reference electrode potentials, titration continues to the electric potential inflection (to show bound iodine content). Amylose is calculated assuming 1.0 g amylose per 200 mg bound iodine.

Starch useful as a corrugating adhesives may be obtained from a single source by any commonly used method. Illustrative methods for obtaining a starch include milling a starch source, such as pea seed, to obtain a milled composition and separating the starch from at least some of the non-starch components in the milled composition, such as protein and fiber. In some embodiments starch may be separated from protein and fiber using air classification, for example using air countercurrents to distinguish protein, fiber and starch particles from each other based on properties such as weight and density. In other embodiments starch may be separated from protein and fiber using wet methods such as use of hydrocyclones or use of isoelectric point separations, and combinations thereof.

In any embodiment, starch refers to a milled composition obtained from a plant having about 98% starch by dry weight basis or about 99% starch by dry weight basis. In any embodiment, a starch refers to a milled composition obtained from a plant having at least about 85% starch by dry weight basis, or at about 90% starch by dry weight basis, or at least about 95% starch by dry weight basis.

In any embodiment, a corrugating adhesive disclosed herein includes a modified starch. In any embodiment, a corrugating adhesive disclosed herein includes a chemically modified starch. In any embodiment, a corrugating adhesive disclosed herein includes a converted starch. In any embodiment, a corrugating adhesive disclosed herein includes an oxidized starch. In any embodiment, a corrugating adhesive disclosed herein includes an inhibited starch (including inhibition by physical means such as a thermally inhibited starch). In any embodiment, a corrugating adhesive disclosed herein includes a crosslinked starch. In any embodiment, the starch used in a corrugating adhesive disclosed herein is stabilized. Other modifications include esterification such as acetylation, formation of starch phosphates or sulfates, etherification such as hydroxypropyl or cationic derivatives, hydrolysis by acid or enzyme, treatment with alkali, or solvent treatments such as dimethyl sulfoxide or similar solvent. Typical modifications are discussed in the following reference: Starch: Chemistry and Technology, edited by R. L. Whistler, et al., Chapters X and XVII, 1984 and Modified Starches: Properties and Uses, edited by 0. B. Wurzburg, Chapters 2-6, 9 and 11, 1986.

In any embodiment, an oxidized starch useful in a corrugating adhesive disclosed herein is oxidized using one or more of sodium hypochlorite, hydrogen peroxide, persulfates, peracetic acid or permanganates, or any combination of oxidants and oxidizing processes may further use metal ions as a catalyst. Illustrative hydrogen peroxide-based oxidations are described in U.S. Pat. Nos. 3,655,644; 4,838,944, or 5,833,755, all of which are incorporated herein by reference, and all of which are useful for making an oxidized starch for use in a corrugating adhesive. In any embodiment, a starch useful in a corrugating adhesive disclosed herein is oxidized using active chlorine. In any embodiment, the active chlorine used to oxidize a starch useful in a corrugating adhesive disclosed herein is provided by sodium hypochlorite. In any embodiment, a starch useful in a corrugating adhesive disclosed herein is oxidized by active chlorine in an amount from about 0.01% to about 1% or about 0.01% to about 0.9% or about 0.01% to about 0.7% or about 0.01% to about 0.5% or about 0.01% to about 0.3% or about 0.02% to about 0.3% or about 0.02% to about 0.5% or about 0.02% to about 0.6% or about 0.03% to about 0.6% or about 0.03% to about 0.5% or about 0.03% to about 0.04% by weight of the starch. In any embodiment, a starch useful in a corrugating adhesive disclosed herein is oxidized by active chlorine in an amount of about 0.01% to 1% by weight of the starch. In any embodiment, a starch useful in a corrugating adhesive disclosed herein is oxidized by active chlorine in an amount of about 0.02% to about 0.6% by weight of the starch. In any embodiment, a starch useful in a corrugating adhesive disclosed herein is oxidized by active chlorine in an amount of about 0.03% to about 0.3% weight of the starch.

In any embodiment, a starch useful in a corrugating adhesive disclosed herein is oxidized by adding enough sodium hypochlorite solution to a mixture of starch and water to provide the mixture a desired amount of active chlorine. Starch in the presence of active chlorine will oxidize at acidic, neutral and basic pH. In any embodiment, a starch useful in a corrugating adhesive disclosed herein is oxidized at pH of about 4 to about 12, or about 6 to about 11 or about 6 to about 10 or about 6 to about 9. In any embodiment, a starch useful in a corrugating adhesive disclosed herein is oxidized at a pH between 7 and 10. In any embodiment, a starch useful in a corrugating adhesive disclosed herein is oxidized to a pH of about 7 to about 9. If necessary, pH of a starch and chloride solution is adjusted using any suitable base, for example including, but not limited to sodium carbonate, sodium citrate, tetrasodium pyrophosphate, ammonium orthophosphate, disodium orthophosphate, trisodium phosphate, calcium carbonate, calcium hydroxide, potassium carbonate, potassium hydroxide, and potassium citrate, but commonly using sodium hydroxide.

In any embodiment, an oxidized starch slurry has altered viscosity profile compared to a native starch slurry, particularly in the presence of alkali. In any embodiment, an oxidized starch slurry has a higher peak viscosity than a native starch slurry, particularly in the presence of alkali. In any embodiment, an oxidized starch slurry has increased viscosity at substantially equal temperature compared to a native starch slurry, particularly in the presence of alkali. In any embodiment, the viscosity of the starch slurry can be measured using a Brabender Micro-Visco-Amylo-graph using the following procedure: slurry (6 grams starch dry basis dispersed is 103 grams of water and 0.5 grams sodium hydroxide) is heated from 40° to 90° C. In any embodiment, a starch slurry subjected to foregoing test will have a peak viscosity (highest observed viscosity) followed by viscosity break down. In any embodiment, an oxidized starch has a peak viscosity of about 2,300 to about 3,000 Brabender Units (BU) or about 2,400 to about 2,700 BU.

In another embodiment a starch useful in making a corrugating adhesive disclosed herein is a crosslinked starch. In any embodiment, starch useful in a corrugating adhesive disclosed herein is crosslinked using phosphorous oxychloride, anhydrous dicarboxylic acids (like adipic anhydride, or mixture of acetic and adipic anhydride), or trimetaphosphate salts or other monophosphate linkage reactants.

In any embodiment, a starch useful in a corrugating adhesive disclosed herein is crosslinked using phosphorous oxychloride (POCl₃). In any embodiment, a starch useful in a corrugating adhesive disclosed herein disclosed herein may be crosslinked with about 1 to about 100 ppm POCl₃, or about 1 to about 75 ppm or about 1 to about 50 ppm or about 1 to about 40 ppm or about 1 to about 30 ppm or about 1 to about 20 ppm, or about 5 to about 50 ppm or about 10 to about 50 ppm or about 20 to about 50 ppm or about 20 to about 40 ppm. In any embodiment, a starch useful in a corrugating adhesive disclosed herein is crosslinked with between about 15 and 45 ppm POCl₃. In any embodiment, a starch useful in a corrugating adhesive disclosed herein is crosslinked with between 20 and 30 ppm POCl₃. In any embodiment, a starch useful in a corrugating adhesive disclosed herein is crosslinked with about 25 ppm POCl₃.

In any embodiment, a crosslinked starch useful in a corrugating adhesive disclosed herein is made by mixing with an aqueous starch slurry, a desired amount of POCl₃, such as those described above, and adjusting the mixture's pH from about 11 to about 12, using any suitable base including but not limited to sodium carbonate, sodium citrate, tetrasodium pyrophosphate, ammonium orthophosphate, disodium orthophosphate, trisodium phosphate, calcium carbonate, calcium hydroxide, potassium carbonate, potassium hydroxide, and potassium citrate, but commonly using sodium hydroxide. In any embodiment, a starch useful in a corrugating adhesive disclosed herein is crosslinked from about 15 minutes to about 90 minutes, or from about 30 to about 60 minutes, at from about 20° C. to about 30° C. In any embodiment, a starch a crosslinking reaction is stopped by adding enough acid reduce the solution's pH to neutral or acidic.

The present technology pertains to improved corrugating adhesives and is applicable to all starch based corrugating adhesive systems. In any embodiment, a composition for making a carrier component type (or carrier type or Stein-hall type) corrugating adhesive disclosed herein includes a carrier component and a suspended component. In any embodiment, a corrugating adhesive disclosed herein is a no-carrier type adhesive. In any embodiment, a carrier adhesive is a carrier/no carrier, for example a Minocar process adhesive.

In any embodiment, a corrugating adhesive disclosed herein is a no-carrier type adhesive. In any embodiment, a no-carrier type adhesives includes a suspended component that includes starch, water, and caustic. In contrast, to carrier component-type adhesive, a no-carrier type adhesive does not include a gelatinized starch. In any embodiment, a no-carrier type adhesive includes insufficient caustic to gelatinize the suspended starch. In any embodiment, the amount of caustic is determined by a desired viscosity, which may be measured by any method known in the art, for example a Rapid Visco-Analyzer machine. In any embodiment, a no-carrier adhesive may use a native starch or a modified starch (including pea or legume starch). In any embodiment, a no-carrier adhesive is made by mixing a caustic agent with a starch slurry and measuring the viscosity of the slurry. When the slurry reaches a desired viscosity, acid, commonly boric acid, is added to neutralize the caustic.

In any embodiment, an adhesive is a carrier/no carrier adhesive or a Minocar type carrier/no-carrier adhesive. In any embodiment, a carrier/no carrier adhesive includes starch and water. Like a carrier component-type adhesive, a carrier/no carrier adhesive includes a carrier component that includes gelatinized starch. The starch in the carrier component may be native or modified. Also like a carrier component-type adhesive, a carrier/no carrier type adhesive includes a suspended starch component that includes starch and water. Unlike a carrier component-type adhesive, a carrier/no carrier adhesive includes a caustic in the suspended component to adjust the viscosity of the adhesive. Like a no-carrier adhesive the viscosity of a carrier/no carrier type adhesive may be measured by any process known in the art, for example, using a Rapid Visco-analyzer machine. Once the desired viscosity is obtained, the caustic is neutralized by adding acid, commonly boric acid.

In any embodiment, a corrugating adhesive disclosed herein includes modified starch in an amount of about 15% to about 40% by weight, or about 18% to about 35% or about 20% to about 30% of the total adhesive wet weight.

In any embodiment, a corrugating adhesive disclosed herein includes a suspended component that includes a granular starch, which may be a native starch or a modified starch. Granular starch is an understood term within the art and is intended to have its full meaning. In any embodiment, a granular starch is ungelatinized, which may be determined by the appearance of a Maltese-cross diffraction pattern when the starch is viewed under polarized light. In any embodiment, a granular starch is a pea or legume starch. In any embodiment, a granular starch has amylose content of about 30% to less than 40%, or about 30% to about 39%, or about 33% to 38%, or about 34% to about 36%, or about 35% amylose by weight of the starch. In any embodiment, a granular starch is a modified starch, examples of which include oxidized starch, crosslinked starch, derivatized starches such as starch ethers, esters, acid hydrolyzed and alkali or solvent treated starches. In any embodiment, a granular starch is swollen starch, (i.e. not fully pasted) starch. In any embodiment, granular starch may be swollen by means of caustic added to a suspended component.

In any embodiment, a suspended component of a corrugating adhesive disclosed herein includes a granular starch and water. In any embodiment, a suspended component of a corrugating adhesive disclosed herein consists essentially of a granular pea starch or a granular modified pea starch and water. In any embodiment, a suspended component consists of granular pea starch or a granular modified pea starch and water. In any embodiment, a suspended component includes about 15% to about 40% by weight granular starch of the total adhesive, or about 18% to about 35% or about 20% to about 30% of the total adhesive wet weight.

In any embodiment, a suspended component includes about 15% to about 40% oxidized starch by weight of the total adhesive wet weight. In any embodiment, a suspended component incudes about 18% to about 35% oxidized starch, by weight of the total adhesive wet weight. In any embodiment, suspended component includes about 20% to about 30% oxidized by weight of the total adhesive wet weight.

In any embodiment, a suspended component includes about 15% to about 40% crosslinked starch by weigh to the total adhesive wet weight. In any embodiment, a suspended component includes about 18% to about 35% crosslinked starch in a total adhesive wet weight. In any embodiment, suspended component incudes about 20% to about 30% oxidized by weight of the total adhesive wet weight.

In any embodiment, a corrugating adhesive disclosed herein can include a carrier component that includes a gelatinized starch. In any embodiment, a gelatinized starch in a carrier component is obtained from the same base starch as a granular starch in a suspended component. In any embodiment, a gelatinized starch in carrier component is a different base starch than a granular starch in a suspended component. In any embodiment, a gelatinized starch in a carrier component is a pea starch. In any embodiment, a gelatinized starch has amylose content of about 30% to less than 40%, or about 30% to about 39%, or about 33% to 38%, or about 34% to about 36%, or about 35% amylose by weight of the starch. In any embodiment, a gelatinized starch is a modified starch, examples of which include oxidized starch, crosslinked starch, derivatized starches such as starch ethers, esters, acid hydrolyzed and alkali or solvent treated starches. In any embodiment, a gelatinized starch is an oxidized starch. In any embodiment, a gelatinized starch is crosslinked starch.

In any embodiment, a carrier component includes a gelatinized starch and water. In any embodiment, a carrier component includes a modified and gelatinized starch and water. In any embodiment, a carrier component includes a modified and oxidized legume or pea starch. In any embodiment, a carrier component includes gelatinized starch in an amount of about 1% to about 15% starch by weight of the total adhesive wet weight, or about 2% to about 10%, or about 2% to about 6% of the total adhesive wet weight. In any embodiment, a carrier component includes about 3% to about 5% starch by weight of the total adhesive wet weight.

In any embodiment, a carrier component includes about 1% to about 15% oxidized starch by weight of the total adhesive wet weight, or about 2% to about 10%, or about 2% to about 6% oxidized starch of the total adhesive wet weight. In any embodiment, a carrier component includes about 3% to about 5% oxidized starch by weight of the total adhesive wet weight. In any embodiment, a carrier component includes an oxidized and gelatinized starch. In any embodiment, a carrier component includes and oxidized and gelatinized pea starch.

In any embodiment, a carrier component includes about 1% to about 15% starch by weight of the total adhesive wet weight, or about 2% to about 10%, or about 2% to about 6% crosslinked starch of the total adhesive wet weight. In any embodiment, a carrier component includes about 3% to about 5% crosslinked starch by weight of the total adhesive wet weight. In embodiment, a carrier component includes a crosslinked and gelatinized starch. In any embodiment, a carrier component includes a crosslinked and gelatinized pea starch.

In any embodiment, a carrier component including a crosslinked starch requires less starch to obtain an adhesive having a substantially equivalent bond strength as an adhesive including a native starch. In any embodiment, an adhesive including a crosslinked starch requires less starch to obtain an adhesive having a substantially equivalent bond strength as an adhesive including a native starch.

In any embodiment, a carrier component includes a caustic agent. In any embodiment, a carrier component includes enough caustic agent to reduce gelatinization temperature of a starch or modified starch. In any embodiment, a carrier component includes enough caustic agent to gelatinizing a starch. In any embodiment, a carrier component includes enough sodium hydroxide to gelatinize a starch. In any embodiment, a carrier component includes about 1% to about 40% sodium hydroxide by weight of starch in the carrier, or about 5% to about 30%. In any embodiment, a carrier component includes between about 10% and 15% sodium hydroxide by weight of the carrier starch. In any embodiment, a carrier component includes 0% sodium hydroxide.

In any embodiment, a carrier component consists essentially of starch, water and sodium hydroxide. In any embodiment, a carrier component consists of starch, water and sodium hydroxide. In any embodiment, a carrier component consists essentially of starch and water. In any embodiment, a carrier component consists of starch and water.

In any embodiment, a carrier component includes a crosslinking agent. In any embodiment, a carrier component includes a boron containing compound. In any embodiment, a carrier component includes borax, boric acid, or other boron containing crosslinking agent. In any embodiment, a carrier component includes about 1% to about 20% borax by weight of the starch in the carrier, or about 3% to about 18%, or about 5% to about 15% of the weight of starch in the carrier. In any embodiment, a carrier component includes 0% borax.

In any embodiment, a corrugating adhesive disclosed herein is substantially free of boron. In any embodiment, a carrier component of a corrugating adhesive disclosed herein is substantially free of boron. In any embodiment, a suspended component of a corrugating adhesive disclosed herein is substantially free of boron. Within this specification substantially boron free means less than about 0.02% boron by weight of the composition (adhesive, carrier component, or suspended component as context dictates).

In any embodiment, a corrugating adhesive disclosed herein comprises a modified pea starch, water and optionally sodium hydroxide. In any embodiment, a corrugating adhesive disclosed herein consists essentially of a modified pea starch, water and optionally sodium hydroxide. In any embodiment, a corrugating adhesive disclosed herein consists of a modified starch, water and sodium hydroxide. In any embodiment, a corrugating adhesive disclosed herein includes an oxidized pea starch, water and optionally sodium hydroxide. In any embodiment, a corrugating adhesive disclosed herein includes of a phosphate crosslinked pea starch, water and optionally sodium hydroxide.

In any embodiment, a corrugating adhesive disclosed herein includes a granular starch. In any embodiment, a corrugating adhesive disclosed herein consists essentially of a granular starch, such starch optionally being swollen by caustic agent. In any embodiment, a corrugating adhesive disclosed herein includes gelatinized starch portion and a granular starch granular.

The disclosed technology pertains to methods for making a corrugating adhesive disclosed herein. In any embodiment, a corrugating adhesive disclosed herein is made by pasting a mixture of a first starch and water to form a carrier component and adding a mixture of a second starch and water to the carrier component. In any embodiment, the first starch and the second starch are the same type of starch. In any embodiment, the first starch and the second starch are a pea starch. In any embodiment, a first starch and a second starch are modified starches. In any embodiment, a first starch and a second starch have the same modification. In any embodiment, the first starch and second starch are oxidized, or crosslinked, or both.

In any embodiment, a first starch is pasted in a mixture of water and sodium hydroxide. In any embodiment, a first starch is pasted at a temperature of about 90° F. (about 32° C.) to about 170° F. (about 76° C.), or between about 100° F. (about 38° C.) and about 1450° F. (63° C.), or between about 100° F. (about 38° C.) and about 1250° F. (52° C.).

In any embodiment, the corrugating adhesive disclosed herein has a gelatinization temperature (gel temp) of between 1200° F. (about 490° C.) to about 1600° F. (about 71°), or between 1300° F. (about 540° C.) and about 1450° F. (about 63° C.), or between about 1350° F. (about 570° C.) and about 1400° F. (about 60° C.).

In any embodiment, a method of making a corrugating adhesive disclosed herein includes mixing a modified starch having amylose content of 30% to less than 40% with water. In any embodiment, the method of making the corrugating adhesive disclosed herein further includes mixing a caustic agent to the mixture of modified starch and water. In any embodiment, a method of making the corrugating adhesive disclosed herein includes adding enough caustic agent to increase the viscosity of modified starch and water mixture. In any embodiment, a method of making the corrugating adhesive disclosed herein includes adding caustic agent to gelatinize at least a part of the modified starch in the adhesive. In any embodiment, the method of making a corrugating adhesive disclosed herein includes adding enough caustic agent to gelatinize a first part of a modified starch suspended in a first part of water in the adhesive, adding a second portion of water to the carrier component to dilute the carrier component and adding a second portion of the modified starch to the dilute carrier component. In any embodiment, the method of making a corrugating adhesive disclosed herein includes optionally adding a boron containing material as a crosslinking agent. In any embodiment, the method of making a corrugating adhesive disclosed herein includes optionally adding additional additives such as ketone aldehyde resins or performance additives to improve functionality.

In a non-limiting illustrative embodiment of an adhesive disclosed herein and a method for making such adhesive, a 9-gallon batch (about 34.1 L) of such adhesive includes about 20 to about 30 lbs. (about 9 to about 13 kg) water, 1-4 lbs. (0.5 to 1.8 kg) starch, and about 0.25 to about 0.5 lb. (about 0.1 to about 0.5 kg) sodium hydroxide. Starch, water and sodium hydroxide are mixed to form a carrier component (also called primary component). Borax may be added to the carrier component in amount of about one-fifth pound to about one-third pound (about 0.2 to about 0.33 lbs.) (about 0.9 to about 0.15 kg). (One ordinary skill in the art, however, would understand that water in carrier component in part is interchangeable with water in suspended component (also called a secondary component). Water and starch (and other additives as needed), which make up (at least in part) the suspended component are then added to the carrier component to finish the adhesive. The suspended component may be mixed to form a separate component that is added to the carrier component, or the individual ingredients of the suspended component may be added separately to the carrier component. In any embodiment, a corrugating adhesive disclosed herein is finished by diluting the carrier portion with water followed by adding a starch (or second starch as described above). In a non-limiting, illustrative example, for a 9-gallon adhesive, (34.1 L) about 30 lbs. to about 40 lbs. (about 13.6 to about 14.1 kg) of additional water is added to dilute the carrier component resulting in a total water content of about 60% to about 85% by weight of the adhesive, or about 70% to about 80% water by weight of the adhesive. Following dilution, additional granular starch is added to dilute carrier component and is suspended by mixing. In any embodiment, starch is suspended in the carrier component in an amount of about 15 to about 25 lbs. (about 6.8 to about 11.3 kg).

Optionally, additional resins, film formers, rheology modifiers, thickeners and defoaming agents may be added to the adhesive disclosed herein as part of the suspended component and may be added dilution of the carrier component and may be added before or after addition of the granular starch.

In any embodiment, a corrugating adhesive, as described herein, is substantially free of additional wet strength resins, such as ketone-aldehyde resins. In any embodiment, a corrugating adhesive as describe herein includes no added wet strength resin. In any embodiment, a corrugating adhesive includes 0% wet strength resin.

The recitation of various embodiments and aspects of the technology illustrative are not limiting. Other embodiments and aspects of the technology that are not specifically recited in this specification would be within the skill of one of ordinary skill in the art, and as such are encompassed by the scope of the claims either literally or by equivalence at least by reason of the following.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology including the addition of chemical or resins to alter the functionality of the corrugating adhesive. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology is further described in the following aspects, which are intended to be illustrative, and are not intended to limit the full scope of the claims and their equivalents.

In a first aspect, the technology pertains to a corrugating adhesive comprising: a granular modified starch having an amylose content of about 30% to less than 40% (by weight).

In a second aspect, the technology pertains to the corrugating adhesive of the first aspect wherein the modified starch is a legume starch or a pea starch.

In a third aspect, the technology pertains to the corrugating adhesive of the first or second aspects, further comprising water.

In a fourth aspect, the technology pertains to the corrugating adhesive of any one of the first to third aspects, wherein a modification of the modified starch is selected from the group consisting of an oxidization, inhibition, crosslinking, stabilization, esterification, acetylation, etherification, hydroxypropylation, cationization, acidic hydrolyzation, enzymatic hydrolyzation, alkali modification, solvent modification and mixtures thereof.

In a fifth, aspect the technology pertains to the corrugating adhesive of any one of the first to fourth aspects, further comprising a caustic agent, and, optionally, wherein the caustic agent is sodium hydroxide.

In a sixth, aspect the technology pertains to the corrugating adhesive of any one of one of the first to fifth aspects, further comprising a boron agent, and, optionally, wherein the boron agent is borax.

In seventh, aspect the technology pertains to the corrugating adhesive of any one of the first to sixth aspects, consisting essentially of the modified starch, the water, the caustic agent, and/or the boron agent.

In an eighth aspect, the technology pertains to the corrugating adhesive of any one of the first to seventh aspects, wherein a portion of the modified starch is granular, and a portion of the modified starch is gelatinized.

In a ninth aspect, the technology pertains to the corrugating adhesive of any one of the first to eight aspects, wherein the modified starch is an oxidized starch.

In a tenth aspect, the technology pertains to the corrugating adhesive of any one of the first to ninth aspects, wherein the modified starch is oxidized by chlorine, sodium hypochlorite, or a combination thereof.

In an eleventh aspect, the technology pertains to the corrugating adhesive of any one of the first to tenth aspects, wherein the modified starch is oxidized in a process comprising 0.01% to 1% active chlorine.

In a twelfth aspect, the technology pertains to the corrugating adhesive of any one of the first to eleventh aspects, wherein the starch is oxidized such that a slurry (6 grams of the oxidized starch (dry basis) dispersed in 103 grams of water containing 0.5 grams sodium hydroxide) heated from 40° to 90° C. has a peak viscosity of 2,300 to 3,000 Brabender Units (BU).

In a thirteenth aspect, the technology pertains to the corrugating adhesive of any one of the first to twelfth aspects, wherein the modified starch is a crosslinked starch, and, optionally, wherein the modified starch is crosslinked in a process comprising 1 ppm to 100 ppm POCl3.

In a fourteenth aspect, the technology pertains to the corrugating adhesive of any one of the first to thirteenth aspects, wherein the adhesive comprises a carrier component and a suspended component, and wherein the carrier component and the suspended component each comprise a modified starch.

In a fifteenth aspect, the technology pertains to the corrugating adhesive of any one of the first to fourteenth aspects, wherein the adhesive comprises a carrier component and a suspended component, each component comprising a modified starch, and wherein: the modified starch in the carrier component is obtained from the same base starch as the modified starch in the suspended component; (ii) the modified starch in the carrier component is modified by the same modification as the modified starch in the suspended component; (iii) the modified starch in the carrier component is also gelatinized; (iv) the modified starch in the carrier component is also gelatinized, using caustic agent; (v) the modified starch in the suspended component is a granular starch; or (vi) a combination of two or more of (i) to (v).

In a sixteenth aspect, the technology pertains to the corrugating adhesive of any one of the first to fifteenth aspects having a wet pin to dry pins ratio (%) of 1 to 10% or about 1% to 7% or about 2% to about 7% or about 3% to about 7%. In any embodiment, a corrugating adhesive has a wet pins to dry pins ratio (%) of about 3% to about 6% or about 3% to about 5%.

In a seventeenth aspect, the technology pertains to the corrugating adhesive of any one of the first to fifth, and seventh to sixteenth aspects being substantially boron free.

In an eighteenth aspect, the technology pertains to the corrugating adhesive of any one of the first to seventeenth aspects, wherein the adhesive includes about 15% to about 40% starch by weight of the wet weight of the total adhesive.

In a nineteenth aspect, the technology pertains to the corrugating adhesive of any one of the first to eighteenth aspects, wherein the adhesive includes a carrier component having a modified starch in an amount of about 1% to about 15% by weight of the wet weight of the total adhesive.

In a twentieth aspect, the technology pertains to the corrugating adhesive any one of the first to nineteenth aspects being substantially free of wet strength resins or comprising 0% wet strength resins.

In a twenty-first aspect, the technology pertains to a corrugated material comprising the corrugating adhesive of any one of the first to twentieth aspects.

In a twenty-second aspect, the technology pertains to the corrugated material of the twenty-first aspect, the wherein the corrugating material has a wet pins to dry pins ratio (%) of about 1% to about 10% or about 1% to 7% or about 2% to about 7% or about 3% to about 7%, or of about 3% to about 6%, or about 3% to about 5%, and optionally wherein the corrugated material is a double wall or triple wall corrugated material.

In a twenty-third aspect, the technology pertains a method of making the corrugating adhesive of any one of the first to twentieth aspects, comprising mixing a modified starch having an amylose content of 30% to less than 40% (by weight) with water to form a mixture of modified starch and water, wherein said mixture of modified starch and water is, optionally, further mixed with a caustic agent.

In a twenty-fourth aspect, the technology pertains to the method of making the corrugating adhesive of the twenty-third aspect, wherein enough caustic agent is added to increase the viscosity of the mixture of modified starch and water at an elevated temperature.

In a twenty-fifth aspect, the technology pertains to the method of making the corrugating adhesive of the twenty-third or twenty-fourth aspects, wherein enough caustic is added to gelatinize at least a part of the modified starch in the adhesive.

In a twenty-sixth aspect, the technology pertains to the method of making the corrugating adhesive of any one of the twenty-second to twenty-fifth aspects, wherein the modified starch is a first portion of the modified starch and the water is a first portion of the water, and wherein the method further comprises mixing the first portion of the modified starch, the first portion of the water and the caustic for sufficient time to gelatinize the first portion of the modified starch to form a carrier component, adding a second portion of the water to the carrier component to dilute the carrier component and adding a second portion of the modified starch to the diluted carrier component.

In a twenty-seventh aspect, the technology pertains to a method for making a corrugated material comprising: (1) providing (a) a medium, (b) a single face liner, (c) an adhesive as described in any one of the first to nineteenth aspects and (d) corrugating equipment including an upper corrugating roller, a low corrugating roller, an adhesive applicator, and a single face roller (2) corrugating the medium between the upper corrugating roller and lower corrugating roller to obtain a fluted medium, (3) applying the corrugating adhesive to the fluted medium, and (4) affixing the single face liner to the fluted medium.

In a twenty-eighth aspect, the technology pertains to the method the twenty-seventh aspect further providing additional liners and obtaining additional fluted media to obtain a double wall or higher order wall corrugated material.

In a twenty-ninth aspect, the technology pertains to the method the twenty-seventh or twenty-eighth aspects wherein the corrugating material has a wet pins to dry pins ratio (%) of about 1% to about 10% or about 1% to 7% or about 2% to about 7% or about 3% to about 7%, or of about 3% to about 6%, or about 3% to about 5%.

In a thirtieth aspect, the technology pertains to the method of any one of the twenty-seventh to twenty-ninth aspects the corrugating material is a double wall corrugating material and wherein the double wall corrugating material is made at a rate of at least about 1.25 time faster than the same production processes using a pearl corn adhesive or at least about 1.5 times or at least about 1.75 time or at least about 2 times (or up to about 2 times or 2 times faster).

In a thirty-first aspect, the technology pertains to the method of any one of the twenty-seventh to twenty-ninth aspects wherein the corrugating material is a triple wall corrugating material and wherein the triple wall corrugating material is made at a rate of at least about 1.25 time faster than the same production processes using a pearl corn adhesive or at least about 1.5 times or at least about 1.75 time or at least about 2 times (or up to about 2 times or 2 times faster).

The technology is further described by the following examples, which are intended to be illustrative and are not intended to limit the full scope of the claims or their equivalents.

### EXAMPLE 1—SAMPLE GENERATION AND ANALYSIS

Adhesives were generated with a mixing tank and high shear mixer, using saw toothed mixer blades at various diameters between 2″ and 6″ and RPMs between 1,750 and 3,000 rpms in order to simulate the tip speed of a commercial corrugating high shear starch reactor (typically 12″ diameter and 1750 rpm). Carrier component water was preheated to Temp 95° to 1400° F. (35° to 600° C.). Starch was added and dispersed, then sodium hydroxide was added, and carrier starch was gelatinized (by mixing for about 60 to 240 seconds). Optionally, a boron containing crosslinker was then added and the carrier component was mixed for 120 to 500 seconds. The suspended component water (Temp 26.7° (−2.6° C.) to 43.3° F. (6.2° C.)) was then added to the carrier component followed by the secondary starch. The adhesive was mixed for a further 60 to 120 seconds and was then transferred to an insulated storage vessel. The adhesive was stored with intermittent stirring and consumed within 4 hours of manufacture. Lab samples were generated in volumes between 1 and 10 liters, machine scale samples were generated in 18.9 to 75.70-gallon (about 71.5 to about 286) batches.

Each adhesive was tested to determine both Stein Hall viscosity (in seconds) and adhesive temperature and to determine adhesive gel temperature (“gel temp”). Stein Hall viscosity is measured as the seconds required for an adhesive to pass through a Stein-Hall cup, such viscosity may be called a Stein-Hall viscosity and may be measured in Stein-Hall seconds, (s (SH)). In any embodiment, a Stein-Hall viscosity of a corrugating adhesive disclosed herein may be measured as follows. The adhesive is placed in a calibrated Stein Hall cup which has been equilibrated to adhesive temperature, typically strained to remove particulates. The adhesive drains from the bottom orifice in the cup and a stopwatch is used to time the period as adhesive passes from the first to second pin in the cup. Both time in seconds and adhesive temperature are recorded as values, as adhesive viscosity will change with temperature.

Gel temp was determined as follows: heat approximately 20 ml of adhesive in a test tube in a 180° F. (82.2° C.) water bath while stirring with a glass thermometer. The temperature when the adhesive set to a rigid gel was recorded.

Procedure for generating lab board samples for testing: Samples of C-Flute single face web (single face liner with fluted medium bonded to it but no backing liner) were cut into 6″×6″ (15.2 to 15.2 cm) sections, as was sample of liner paper. Adhesive was spread on a flat glass surface using a 10-mil garner knife or suitable controlled spreading tool. The flutes from the single face web were dipped into the adhesive film, and the 6″×6″ (15.2 to 15.2 cm) liner paper was applied onto the adhesive on the flutes. The combined board was placed in a hydraulic press with a heated plate set at 400° F. (204° C.) and compressed to no more than 50 psi (344.7 kPa) for 10 second. The combined board was conditioned and cut into samples according to TAPPI methods T-821 or T-845 and analyzed. For lab samples, only the Double Back bond was measured as the single face bond was prepared on a commercial corrugator.

For machine scale testing, adhesive was circulated from the storage container into the glue pan for both the single face and double back sections of the corrugator. Settings were recorded for machine speed, adhesive gap (distance between adhesive applicator and metering rolls, which controls the level of adhesive applied), and temperatures of various sections of the machine and the moving paper. Additional variables such as speed of rolls and type of rolls were documented as appropriate. Finished board samples were collected and analyzed for both single face and double back pin adhesion (both dry and wet pins). Dry bond strength (in dry pins) and wet bond strength (wet pins) ware measured as described in T-821 or T-845.

### EXAMPLE 2—COMPARATNE EXAMPLES PREPARING ADHESIVES CONTAINING NATNE PEA STARCH

Samples of adhesives using native pea starch in the carrier and suspended portions and native pea starch in the carrier portion and native corn starch in the suspended portion were made in lab scale adhesives according the properties defined in the following tables. These samples were made as comparative samples to illustrate the effect of modifying pea starch on the wet bond strength of the adhesives. Table 1a recites formulations of two-part adhesives containing native pea starch in the carrier component and the suspended component (Formula 1) with adhesives containing native pea starch in the carrier component and dent corn starch in the suspended component (Formula 2). Table 1b. recites the dry bond strength (dry pins) wet bond strength (wet pins) and ratio of wet bond to dry bond strength.

TABLE 1a
Formulation -Adhesives Containing Native Pea Starch
in the Carrier component and Native Corn Starch
or Native Pea Starch in the Suspended Component

| | | Formula 1 | Formula 2 |
|---|---|---|---|
| Carrier | Carrier Water % | 30.1% | 30.4% |
| Component | Carrier Starch % | 2.6% | 2.7% |
| | 50% NaOH % | 0.8% | 1.0% |
| | Borax % | 0.2% | 0.2% |
| | Wet Strength Resins | 0% | 0% |
| Suspended | Suspension Water % | 42.1% | 42.6% |
| Component | Suspension Starch % | 24.1% | 23.1% |
| | Starch Solids in Carrier | 7.9% | 7.9% |
| | NaOH/Carrier Starch | 15.9% | 18.2% |
| | % NaOH Carrier | 1.3% | 1.4% |
| | Total Starch (dry basis) | 24.3% | 23.6% |
| | Carrier Starch/Total Starch % | 9.9% | 10.4% |
| | NaOH/Total Starch | 1.6% | 1.9% |
| | Stein Hall Viscosity (in seconds) | 44 | 40 |
| | Mixing Temp | 36° C. | 36° C. |
| | Gelatinization Temp | 47° C. | 63° C. |

TABLE 1b
Bond Strength

| | Formula 1 | Formula 2 |
|---|---|---|
| Dry pins(N/m) | 884.76 | 858.48 |
| (Double Back Side) | | |
| Wet Pins (N/m) | 18.98 | 4.38 |
| (Double Back Side) | | |
| % W/D (Double Back Side) | 2.1% | 0.5% |

Formula 1 used native pea starch as both the primary and secondary starches, whereas Formula 2 only used native pea starch as the primary starch and dent starch as the secondary starch. As noted in Table 1, the use of a low amylose dent starch as the secondary starch produced an adhesive with a much lower wet pins to dry pins ratio than an adhesive that used native pea starch as both the primary and secondary starches (0.5% versus 2.1%, respectively).

### EXAMPLE 3—PREPARING OXIDIZED PEA STARCH

500 grams of native pea starch in 750 grams of water at pH 8 was treated with between 6-50 ml of hypochlorite solution containing 6% active chloride at room temperature. This was mixed for 25-40 to obtain the desired slurry viscosity. and any residual oxidant was neutralized with concentrated sodium bisulfite solution. The resulting slurry was dewatered in a course fritted disk Buchner funnel under vacuum, and then dried in a laboratory fluid bed dryer at 50° C. until moisture was below 12%.

The viscosity of starch slurry (6 grams dry basis of oxidized starch was dispersed is 103 grams of water containing 0.5 grams sodium hydroxide) was measured using Brabender Micro-Visco-Amylo-graph as the slurry was heated from 40° to 90° C. Slurries were made with native starch and starch of various oxidation levels. Slurry using native starch had peak viscosity of 2,100 to 2,200 Brabender Units (BU) of viscosity. Starch slurry using oxidized starch (0.05 to 0.2% active chlorine) had peak viscosity of 2,400 to 2,700 BU. Starch slurry using oxidized starch (0.3% active chlorine) had peak viscosity of 2,300 to 2,400 BU, Starch slurry using oxidized starch (0.6% and higher) had peak viscosity of 2,100 BU and lower.

### EXAMPLE 4—PREPARING ADHESIVES CONTAINING OXIDIZED PEA STARCH

Based on the forgoing viscosity profile, starch oxidized active chlorine concentrations of 0.07%, 0.22%, and 0.6% were used to make adhesives. The adhesives are described in Table 2. Both the carrier and suspend components of the Formula 3 adhesive contained an oxidized pea starch containing 0.07% chlorine. Both the carrier and suspend components of the Formula 4 adhesive contained an oxidized pea starch containing 0.22% chlorine. Both the carrier and suspend components of the Formula 5 adhesive contained an oxidized pea starch containing 0.6% chlorine. Each of the Formula 3, 4, and 5 adhesive formulations and results associated therewith are reported in Table 2a. Table 2b recites the dry bond strength (dry pins) wet bond strength (wet pins) and ratio of wet bond to dry bond strength.

TABLE 2a
Adhesives Containing Oxidized Pea Starch

| | | Formula 3 | Formula4 | Formula 5 |
|---|---|---|---|---|
| Carrier | Carrier Water % | 30.5% | 30.5% | 29.6% |
| Component | Carrier Starch % | 2.7% | 2.7% | 4.1% |
| | 50% NaOH % | 0.9% | 0.9% | 0.9% |
| | Borax % | 0.2% | 0.2% | 0.2% |
| | Wet Strength Resins | 0% | 0% | 0% |
| Suspended | Suspension Water % | 42.7% | 42.7% | 41.4% |
| Component | Suspension Starch % | 23.2% | 23.2% | 23.7% |
| | Starch Solids in Carrier | 7.9% | 7.9% | 12.0% |
| | NaOH/Carrier starch | 15.9% | 15.9% | 10.7% |
| | % NaOH Carrier | 1.3% | 1.3% | 1.3% |
| | Total Starch (dry basis) | 23.5% | 23.5% | 25.4% |
| | Carrier Starch/Total Starch | 10.4% | 10.4% | 14.9% |
| | NaOH/Total Starch | 1.7% | 1.7% | 1.6% |
| | Stein Hall Viscosity (s) | 33 | 26 | 20 |
| | Mixing Temp (° C.) | 36 | 37 | 33 |
| | Gelatinization Temp (° C.) | 56 | 57 | 57 |

TABLE 2b
Bond Strength

| | Formula 3 | Formula4 | Formula 5 |
|---|---|---|---|
| Dry pins (N/m) | 902.28 | 1045.36 | 1059.96 |
| (Double Back Side) | | | |
| Wet Pins (N/m) | 32.12 | 33.58 | 11.68 |
| (Double Back Side) | | | |
| % W/D (Double Back Side) | 3.6% | 3.2% | 1.1% |

### EXAMPLE 5—PREPARING ESTERIFIED (ACETYLATED) PEA STARCH

500 grams of native pea starch in 1,000 g of water at room temperature was treated with 6.7 g of acetic anhydride and 4% sodium hydroxide solutions dropwise. The anhydride and sodium hydroxide solutions were added simultaneously at a rate to maintain pH of the slurry between 8-10 until addition was complete. The resulting slurry was adjusted to pH 6 with dilute sulfuric acid and then dewatered and dried.

### EXAMPLE 6—PREPARING CROSSLINKED PEA STARCH

To native pea starch slurry (tap water, 40% solids (dry basis)) was added 1.0-part NaCl and 1.0-part NaOH as 3% solution, followed by desired POCl3 level (based on 25 to 100 ppm target). The slurry was stirred for 30 minutes, then adjusted to pH 5.5 with 3N HCl, and subsequently dewatered and dried.

### EXAMPLE 7—PREPARING PEA STARCH MONOPHOSPHATE

25 grams of sodium trimetaphosphate (STMP) is dissolved in 200 grams of water, then added to a stirred slurry of 600 grams of pea starch in 700 grams of water. The resulting mixture was stirred for 30 minutes at room temperature and then dewatered with a course fritted disk Buchner funnel under vacuum. The resulting cake was treated in a fluid bed dryer for 20 minutes at 110° C. and 30 minutes at 130° C.

### EXAMPLE 8—PREPARING ADHESIVES CONTAINING MODIFIED PEA STARCHES

Lab scale adhesives were prepared with the modified pea starches prepared hereinabove in Examples 5, 6, and 7. The Formula 6, 7 and 8 adhesives set forth in Table 3 contained the same modified pea starch in the carrier and suspended components. Formulations and results are reported in Table 3. Formula 6 contained a 1.5% acetate pea starch made according to Example 5. Formula 7 contained a 50 ppm POCl₃ crosslinked pea starch made according to Example 6. Formula 8 contained an STMP crosslinked pea starch made according to Example 7. Table 3b recites the dry bond strength (dry pins) wet bond strength (wet pins) and ratio of wet bond to dry bond strength.

TABLE 3a
Adhesives Containing Crosslinked Pea Starch

| | | Formula 6 | Formula 7 | Formula 8 |
|---|---|---|---|---|
| Carrier | Carrier water % | 30.1% | 44.7% | 31.0% |
| component | Carrier Starch % | 2.6% | 2.0% | 2.6% |
| | 50% NaOH % | 0.9% | 0.7% | 0.9% |
| | Borax % | 0.2% | 0.1% | 0.2% |
| | Wet Strength Resins | 0% | 0% | 0% |
| Suspended | Suspension water % | 42.1% | 31.9% | 43.5% |
| Component | Suspension Starch % | 24.1% | 20.4% | 21.9% |
| | starch solids primary | 7.9% | 4.3% | 7.5% |
| | NaOH/primary Starch | 17.0% | 18.1% | 16.8% |
| | % NaOH primary | 1.3% | 0.8% | 1.3% |
| | Total Starch (dry basis) | 24.3% | 20.5% | 22.3% |
| | Carrier Starch/Total Starch | 9.9% | 9.1% | 10.6% |
| | NaOH/Total Starch | 1.7% | 1.6% | 1.8% |
| | Stein Hall Viscosity (s) | 37 | 38 | 50 |
| | Mixing Temp (° C.) | 36 | 33 | 36 |
| | Gelatinization Temp (DC) | 57 | 56 | 57 |

TABLE 3b
Bond Strength

| | Formula 6 | Formula 7 | Formula 8 |
|---|---|---|---|
| Dry pins (Double | 830.74 | 906.66 | 937.32 |
| Back Side) (N/m) | | | |
| Wet Pins (Double | 18.98 | 42.34 | 34.17 |
| Back Side) (N/m) | | | |
| % W/D (Double Back Side) | 2.3% | 4.7% | 3.6% |

### EXAMPLE 9—PREPARING ALKALI TREATED PEA STARCH

600 grams of native pea starch slurried in 800 g of water was treated with 18 grams of sodium hydroxide (added as a 3% solution with stirring). Resulting material was dewatered and dried as in Example 3a. The alkali treated pea starch prepared in accordance with this Example 9 was compared to untreated native pea starch by evaluating the gelatinization temperature of each starch when dispersed in water to a 30% slurry. Native pea starch had a gel temp (as described in Example 1) of 143° F. (61.7° C.), while alkali treated pea starch had (slightly lower gel temp (140° F. (60° C.).

### EXAMPLE 10—PREPARING ADHESIVES THAT DO NOT CONTAIN BORON

Lab scale adhesives were made without adding boron using native pea starch and the modified pea starches prepared in accordance with Examples 3, 6 and 7. The Formula 9 adhesive contained native pea starch. The Formula 10 adhesive contained an STMP crosslinked pea starch (STMP) made according to Example 7. The Formula 11 adhesive contained oxidized pea starch (0.07 Cl) made according to Example 3. The Formula 12 adhesive contained crosslinked pea starch (50 ppm POCl₃) made according to Example 6. Each of the Formula 9, 10, 11, and 12 adhesives used the same starch (whether modified or native) in the carrier and suspended components. The formulations of each adhesive and associated results are reported in Table 4a. Table 4b recites the dry bond strength (dry pins) wet bond strength (wet pins) and ratio of wet bond to dry bond strength.

TABLE 4a
Boron-free Adhesives

| | | Formula 9 | Formula 10 | Formula 11 | Formula 12 |
|---|---|---|---|---|---|
| Carrier | Carrier water % | 30.1% | 36.6% | 30.2% | 44.6% |
| Component | Carrier Starch % | 3.0% | 2.8% | 2.8% | 2.3% |
| | 50% NaOH % | 0.8% | 0.8% | 0.8% | 0.7% |
| | Borax % | 0% | 0% | 0% | 0% |
| | Wet Strength Resins | 0% | 0% | 0% | 0% |
| Suspended | Suspension water % | 42.1% | 36.6% | 42.7% | 31.2% |
| Component | Suspension Starch % | 24.1% | 23.2% | 23.5% | 21.2% |
| | Carrier Starch | 8.9% | 7.0% | 8.4% | 4.9% |
| | NaOH/Carrier Starch | 13.0% | 14.6% | 13.5% | 15.0% |
| | % NaOH Carrier | 1.2% | 1.0% | 1.1% | 0.7% |
| | Total Starch in adhesive (Dry Basis) | 24.5% | 23.5% | 23.8% | 21.3% |
| | Carrier Starch/Total Starch | 11.1% | 10.8% | 10.8% | 10.0% |
| | NaOH/Total Starch in Adhesive | 1.4% | 1.6% | 1.5% | 1.5% |
| | Stein Hall Viscosity (s) | 55 | 37 | 36 | 50 |
| | Mixing Temp (° C.) | 35 | 37 | 33 | 35 |
| | Gelatinization Temp (° C.) | 56 | 58 | 56 | 57 |

TABLE 4b
Bond Strength

| | Formula 9 | Formula 10 | Formula 11 | Formula 12 |
|---|---|---|---|---|
| Dry pins (Double | 782.56 | 861.4 | 876 | 829.28 |
| Back Side) (N/m) | | | | |
| Wet Pins (Double | 18.98 | 35.77 | 38.40 | 35.62 |
| Back Side) (N/m) | | | | |
| % WD (Double Back Side) (N/m) | 2.4% | 4.2% | 4.4% | 4.3% |

### EXAMPLE 11—MACHINE SCALE MODIFIED PEA STARCH ADHESIVES

Adhesives were made at machine scale using variously modified starch and with and without boron. All the adhesives used either native corn starch, (Formula 13), native pea starch (Formula 14), oxidized pea starch (0.05% active chlorine, Formula 15), and crosslinked pea starch (25 ppm POCl3, Formula 16)). Formulations and results are reported in Table 5a. Table 5b recites the dry bond strength (dry pins) wet bond strength (wet pins) and ratio of wet bond to dry bond strength.

TABLE 5a
Machine Scale Adhesives

| | | Formula 13 | Formula 14 | Formula 15 | Formula 16 |
|---|---|---|---|---|---|
| Carrier | Carrier Water % | 36.7% | 30.5% | 30.7% | 50.1% |
| Component | Carrier Starch % | 2.9% | 2.6% | 2.7% | 2.5% |
| | 50% NaOH % | 0.5% | 0.4% | 0.4% | 0.4% |
| | Borax % | 0.3% | 0.2% | 0.2% | 0.2% |
| | Wet Strength Resins | 0% | 0% | 0% | 0% |
| Suspended | Suspension Water % | 36.1% | 41.5% | 41.7% | 22.1% |
| Component | Suspension Starch % | 23.5% | 24.7% | 24.4% | 24.8% |
| | Starch Solids in Carrier | 7.2% | 7.9% | 7.9% | 4.7% |
| | NaOH/Carrier Starch | 19.0% | 16.0% | 15.8% | 17.2% |
| | % NaOH in Carrier | 1.4% | 1.3% | 1.2% | 0.8% |
| | Total Starch Solids in | 24.2% | 24.9% | 24.6% | 24.8% |
| | Adhesive (dry basis) | | | | |
| | Carrier Starch/Total Starch | 10.9% | 9.7% | 9.8% | 9.1% |
| | NaOH/Total Starch in Adhesive | 2.1% | 1.5% | 1.5% | 1.6% |
| | Stein Hall Viscosity (s) | 26 | 19 | 23 | 25 |
| | Mixing Temp (° C.) | 32 | 37 | 36 | 36 |
| | Gelatinization Temp (° C.) | 63 | 57 | 56 | 57 |

TABLE 5b
Bond Strength

| | Formula 13 | Formula 14 | Formula 15 | Formula 16 |
|---|---|---|---|---|
| Dry Pins (Single | 751.90 | 911.04 | 886.22 | 1016.16 |
| Face Side) (N/m) | | | | |
| Dry Pins (Double | 525.60 | 557.72 | 559.18 | 439.46 |
| Back Side) (N/m) | | | | |
| Wet Pins (Single | 0.00 | 30.66 | 36.50 | 36.50 |
| Face Side) (N/m) | | | | |
| Wet Pins (Double Back Side) | 0.00 | 13.14 | 20.44 | 17.52 |
| % W/D (Single | 0.0% | 3.4% | 4.1% | 3.6% |
| Face Side) | | | | |
| % W/D (Double | 0.0% | 2.4% | 3.7% | 4.0% |
| Back Side) | | | | |

### EXAMPLE 12—COMMERCIAL SCALE CORN STARCH ADHESIVE CONTROL

Formula 17, unmodified corn starch was slurried in water at 9.5% (w/w) solids at 1050° F. (about 40.50° C.) and mixed at 1750 rpm with a saw-toothed mixer. Sodium hydroxide was added at a solution weight of 1.3% and mixed for 6 minutes. Sodium borate pentahydrate (5 mol borax) was added at 0.6% solution weight and mixture is mixed an additional 9 minutes. Additional water at 90° F. (about 32° C.) was added to reduce starch solids to 5% and allowed to disperse, followed by unmodified corn starch to increase total solids to 26%. Mixture was mixed for 6 minutes. Wet strength resin (1% by weight, based on total wet weight, Ingredion Coragum® SR,) was added and allowed to disperse.

Adhesive had viscosity of 35 seconds Stein Hall at 100° F. (about 38° C.), and a gelatinization temperature of 145° F. (about 63° C.).

### EXAMPLE 13—COMMERCIAL SCALE MODIFIED PEA STARCH ADHESIVE

Formula 18, modified pea starch (hypochlorite treated) was slurried in water at 8.5% solids (wt. %) at 110° F. (about 40.5° C.) while mixed at 1750 rpm with a saw-toothed mixer. Sodium hydroxide was added at a solution wt. % of 1.0% and mixed for 3 minutes. Sodium borate pentahydrate (5 mol borax) was added at 0.4% and mixture was mixed an additional 6 minutes. Additional water at 90° F. (about 32° C.) was added to reduce starch solids to 4.5% and allowed to disperse, followed by unmodified corn starch to increase total solids to 26%. Mixture was mixed for 3 minutes. No wet strength resin was added.

Adhesive had viscosity of 32 seconds Stein Hall at 100° F. (about 38° C.), and a gel temperature of 134° F. (about 57° C.).

### EXAMPLE 14—COMMERCIAL SCALE BOARDS PREPARED WITH PEARL CONTROL AND MODIFIED PEA STARCH

Multiwall board samples were prepared in various combinations on a commercial corrugator using various combinations of liners (30, 42, or 56 lb. basis weights) and mediums (23 or 26 lb. basis weights). Double wall board is made by combining a single face web to the back of another single face web, which is combined to a double back liner. Triple wall board includes an additional third single face web.

The unmodified pearl adhesive with wet strength resin (Formula 17, Example 12) was tested as a control adhesive. Paper temperatures of the single face liners and mediums were conditioned to between 170°-210° F. (about 77°-about 990° C.). The single face webs used for the double back side of the multiwall bonds ranged from 160°-210° F. (about 71°-about 99° C.), while the bottom double back liner was cooler at 140°-150° F. (about 60°-about 65.5° C.). Finished board measured 165°-170° F. (74°-about 77° C.) on the top and 195°-205° F. (about 90.5°-about 96° C.) on the bottom. Within these temperatures, double wall speeds were limited to 400 feet per minute (fpm) (122 (m/min)) for board made using Formula 17, and triple wall (using the bottom double back stage) was made at 150 fpm (45 m/min) to attain proper bond.

The same temperature profile was applied to the pea starch without resin adhesive (Formula 18, Example 13), and it was observed that board production speed could be increased substantially using this adhesive without negatively impacting bond quality. The double wall production was increased to 500 fpm (about 152 in/mm) and triple wall speed was increased to 275 fpm (about 84 in/mmn) (limited by belt tension on the machine).

Finished board samples were collected and conditioned to TAPPI standards and tested for dry and wet pin adhesion and for double wall corrugated material are reported in Table 6 and for triple wall corrugated material are reported in Table 7.

TABLE 6
Wet and Dry Pin Adhesion (Commercial
Scale) Double Wall Material

Wet pins

| Newtons/m | SF | DB | SF | DB |
|---|---|---|---|---|
| Doublewall com starch and resin | 4.4 | 17.5 | 20.4 | 21.9 |
| Doublewall modified pea starch | 5.8 | 14.6 | 16.1 | 19.0 |

| | Dry pins | | | |
|---|---|---|---|---|
| Newtons/m | SF | DB | SF | DB |
| Doublewall com starch and resin | 757.4 | 427.6 | 763.3 | 515.2 |
| Doublewall modified pea starch | 919.4 | 575.0 | 791.0 | 716.6 |
| | Wet Dry Ratio | | | |
| Newtons/m | SF | DB | SF | DB |
| Doublewall com starch and resin | 0.58% | 4.10% | 2.68% | 4.25% |
| Doublewall modified pea starch | 0.63% | 2.54% | 2.03% | 2.65% |

TABLE 7
Wet and Dry Pin Adhesion (Commercial Scale) Triple Wall Material

Wet pins

| Newtons/m | SF | DB | SF | DB | SF | DB |
|---|---|---|---|---|---|---|
| Triplewall corn starch and resin | 4.4 | 4.4 | 4.4 | 8.8 | 4.4 | 33.6 |
| Triplewall modified pea starch | 7.3 | 14.6 | 16.1 | 17.5 | 11.7 | 32.1 |

| | Dry pins | | | | | |
|---|---|---|---|---|---|---|
| Newtons/m | SF | DB | SF | DB | SF | DB |
| Triplewall corn starch and resin | 913.6 | 779.3 | 741.4 | 608.6 | 604.2 | 785.2 |
| Triplewall modified pea starch | 996.8 | 760.3 | 969.0 | 710.7 | 610.0 | 754.5 |

| | Ratio | | | | | |
|---|---|---|---|---|---|---|
| Newtons/m | SF | DB | SF | DB | SF | DB |
| Triplewall corn starch and resin | 0.48% | 0.56% | 0.59% | 1.44% | 0.72% | 4.28% |
| Triplewall modified pea starch | 0.73% | 1.92% | 1.66% | 2.46% | 1.91% | 4.26% |

The resulting data demonstrates equivalent or improved performance in board analyses when using the modified pea starch even at higher machine speeds and with more corrugating layers. Typically, higher machine speeds would see a reduction in bond strength performance, specifically when the heat to bond the adhesive is limited.

1. A corrugating adhesive comprising: a granular modified starch having an amylose content of 30% to less than 40% (by weight);
optionally, further comprising water; and
optionally, wherein the modified starch is a legume starch or a pea starch.

2-3. (canceled)

4. The corrugating adhesive of claim 1, wherein a modification of the modified starch is selected from the group consisting of an oxidization, inhibition, crosslinking, stabilization, esterification, acetylation, etherification, hydroxypropylation, cationization, acidic hydrolyzation, enzymatic hydrolyzation, alkali modification, solvent modification and mixtures thereof;
optionally, wherein the modified starch is an oxidized starch; and
optionally, wherein the starch is oxidized such that a slurry (6 grams of the oxidized starch (dry basis) dispersed 103 grams of water containing 0.5 grams sodium hydroxide) heated from 40° to 90° C. has a peak viscosity of 2,300 to 3,000 Brabender Units (BU).

5. The corrugating adhesive of claim 1, further comprising a caustic agent, and, optionally, wherein the caustic agent is sodium hydroxide.

6. The corrugating adhesive of claim 1, further comprising a boron agent, and, optionally, wherein the boron agent is borax;
optionally, wherein the corrugating adhesive consists essentially of the modified starch, the water, the caustic agent, and/or the boron agent.

7. (canceled)

8. The corrugating adhesive of claim 1, wherein a portion of the modified starch is granular, and a portion of the modified starch is gelatinized.

9. (canceled)

10. The corrugating adhesive of claim 1, wherein the modified starch is oxidized by chlorine, sodium hypochlorite, or a combination thereof;
optionally, wherein the modified starch is oxidized in process a comprising 0.01% to 1% active chlorine.

11-12. (canceled)

13. The corrugating adhesive of claim 1, wherein the modified starch is a crosslinked starch, and, optionally, wherein the modified starch is crosslinked in a process comprising 1 ppm to 100 ppm POCl₃.

14. The corrugating adhesive of claim 1, wherein the adhesive comprises a carrier component and a suspended component, and wherein the carrier component and the suspended component each comprise a modified starch;
optionally, wherein the adhesive comprises a carrier component and a suspended component, each component comprising a modified starch, and wherein the modified starch has an attribute selected from the group consisting of:
(a) the modified starch in the carrier component is obtained from the same base starch as the modified starch in the suspended component;
(b) the modified starch in the carrier component is modified by the same modification as the modified starch in the suspended component;
(c) the modified starch in the carrier component is also gelatinized;
(d) the modified starch in the carrier component is also gelatinized, using caustic agent;
(e) the modified starch in the suspended component is a granular starch; and
(f) a combination of two or more of (i) to (v).

15. (canceled)

16. The corrugating adhesive of claim 1, being substantially boron free.

17. The corrugating adhesive of claim 1, wherein the adhesive includes about 15% to about 40% starch by weight of the wet weight of the total adhesive.

18. The corrugating adhesive of claim 1, wherein the adhesive includes a carrier component having a modified starch in an amount of about 1% to about 15% by weight of the wet weight of the total adhesive.

19. The corrugating adhesive claim 1, being substantially free of wet strength resins or comprising 0% wet strength resins.

20. The corrugating adhesive claim 1, where wet strength resin at reduced commercial doses is added.

21. A corrugated material comprising the corrugating adhesive of claim 1;
optionally, wherein the corrugating material has a wet pins to dry pins ratio (%) of about 1% to about 10% or about 1% to 7% or about 2% to about 7% or about 3% to about 7%, or of about 3% to about 6%, or about 3% to about 5%, and
optionally wherein the corrugated material is a double wall or triple wall corrugated material.

22. (canceled)

23. A method of making the corrugating adhesive of claim 1, comprising mixing a modified starch having an amylose content of 30% to less than 40% (by weight) with water to form a mixture of modified starch and water, wherein said mixture of modified starch and water is, optionally, further mixed with a caustic agent.

24. The method of making the corrugating adhesive of claim 23, wherein enough caustic agent is added to increase the viscosity of the mixture of modified starch and water at an elevated temperature;
optionally, wherein enough caustic is added to gelatinize at least a part of the modified starch in the adhesive.

25. (canceled)

26. The method of making the corrugating adhesive of claim 23, wherein the modified starch is a first portion of the modified starch and the water is a first portion of the water, and wherein the method further comprises mixing the first portion of the modified starch, the first portion of the water and the caustic for sufficient time to gelatinize the first portion of the modified starch to form a carrier component, adding a second portion of the water to the carrier component to dilute the carrier component and adding a second portion of the modified starch to the diluted carrier component.

27. A method for making a corrugated material comprising:
(1) providing
(a) a medium,
(b) a single face liner,
(c) an adhesive as described in claim 1, and
(d) corrugating equipment including an upper corrugating roller, a low corrugating roller, an adhesive applicator, and a single face roller
(2) corrugating the medium between the upper corrugating roller and lower corrugating roller to obtain a fluted medium,
(3) applying the corrugating adhesive to the fluted medium, and
(4) affixing the single face liner to the fluted medium.

28. The method of claim 27 further providing additional liners and obtaining additional fluted media to obtain a double wall or higher order wall corrugated material;
optionally, wherein the corrugating material has a wet pins to dry pins ratio (%) of about 1% to about 10% or about 1% to 7% or about 2% to about 7% or about 3% to about 7%, or of about 3% to about 6%, or about 3% to about 5%.

29. (canceled)

30. The method of claim 27;
wherein the corrugating material is made at a rate of at least about 1.25 time faster than the same production processes using a pearl corn adhesive or at least about 1.5 times or at least about 1.75 time or at least about 2 times (or up to about 2 times or 2 times faster); and
wherein the corrugating material is one of a double wall corrugating material and a triple wall corrugating material.

31. (canceled)
